(19) United States
(12) Patent Application Publication
(10) Pub. No.: US 2026/0269366 A1
(43) Pub. Date: Sep. 10, 2026

(54) BATTERY MODULE WITH PLASTIC COOLING PLATES

(71) Applicant: SAMSUNG SDI CO., LTD., Yongin-si (KR)

(72) Inventors: Michael ERHART, Seiersberg-Pirka (AT); Florian PROSSNIGG, Graz (AT); Nikolaus HOCHGATTERER, Graz (AT)

(21) Appl. No.: 19/394,383

(22) Filed: Nov. 19, 2025

(30) Foreign Application Priority Data
Mar. 5, 2025 (EP) 25161955.7

(51) Int. Cl. H01M 10/6557; H01M 10/613; H01M 10/625; H01M 10/633; H01M 50/209; H01M 50/242

(52) U.S. Cl. CPC H01M 10/6557; H01M 10/613; H01M 10/625; H01M 10/633; H01M 50/209; H01M 50/242; H01M 2200/10

(57) ABSTRACT

A battery module with a cooling system including plastic cooling plates is provided, which allows for efficient cooling and extinguishing in case of a thermal run-away because the plastic cooling plate adjacent to the battery cell experiencing the thermal run-away forms an opening, allowing for direct cooling by coolant expelled from the plastic cooling plate.

### CROSS-REFERENCE TO RELATED APPLICATION

The present application claims priority to and the benefit of European Patent Application No. 25161955.7, filed on Mar. 5, 2025, in the European Patent Office, the entire disclosure of which is incorporated herein by reference.

### BACKGROUND

### Field

Aspects of embodiments of the present disclosure relate to a battery module with plastic cooling plates.

### Description of the Related Art

A battery system may include a battery management system (BMS), which is an electronic system that is configured to manage a rechargeable battery cell, battery module, and battery pack, such as by protecting the battery cells from operating outside their safe operating area, monitoring their states, calculating secondary data, reporting the data, controlling an environment, authenticating it, and/or balancing it. For example, the BMS may monitor the state of the battery cell as represented by voltage (e.g., a total voltage of the battery pack or battery modules, or voltages of individual battery cells), temperature (e.g., an average temperature of the battery pack or battery modules, coolant intake temperature, coolant output temperature, or temperatures of individual battery cells), coolant flow (e.g., flow rate and/or cooling liquid pressure), and current. Additionally, the BMS may calculate values based on the above parameters, such as minimum and maximum cell voltage, state of charge (SoC), or depth of discharge (DoD) to indicate the charge level of the battery cell, state of health (SoH; a variously-defined measurement of the remaining capacity of the battery cell as a percent of the original capacity), state of power (SoP; the amount of power available for a defined time interval (or period) given the current power usage, temperature, and other conditions), state of safety (SoS), maximum charge current as a charge current limit (CCL), maximum discharge current as a discharge current limit (DCL), and internal impedance of a cell (to determine open circuit voltage).

The BMS may be centralized such that a single controller is connected to the battery cells through a plurality of wires. In other examples, the BMS may be distributed, with a BMS board installed at each cell and only a single communication cable between the battery cell and a controller. In yet other examples, the BMS may have a modular construction including a few controllers, each handling a certain number of (e.g., a group of) cells, while communicating between the controllers. Centralized BMSs are most economical but are least expandable and are plagued by a multitude of wires. Distributed BMSs are the most expensive but are simplest to install and offer the cleanest assembly. Modular BMSs provide a compromise of the features and problems of the other two topologies.

The BMS may protect the battery pack from operating outside its safe operating area. Operation outside the safe operating area may be indicated by an over-current, over-voltage (e.g., during charging), over-temperature, under-temperature, over-pressure, and ground fault or leakage current detection. The BMS may prevent the battery from operating outside its safe operating parameter by including an internal switch (e.g., a relay or solid-state device) that opens if the battery is operated outside its safe operating parameters, requesting the devices to which the battery is connected to reduce or even terminate using the battery, and actively controlling the environment, such as through heaters, fans, air conditioning, or liquid cooling.

An active or passive thermal management system may be included to provide thermal control of the battery pack and to safely use the battery module by efficiently emitting, discharging, and/or dissipating heat generated from its rechargeable batteries. If the heat emission/discharge/dissipation is not sufficiently performed, temperature deviations may occur between respective battery cells, such that the battery module may no longer generate a desired (or designed) amount of power. In addition, an increase of the internal temperature can lead to abnormal reactions occurring therein, and thus, charging and discharging performance of the rechargeable battery deteriorates and the life-span of the rechargeable battery is shortened.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. In thermal runaway, the battery cell temperature rises incredibly fast and the energy stored is released very suddenly. In extreme cases, thermal runaway can cause battery cells to explode and start a fire. In minor cases, it can cause battery cells to be damaged beyond repair.

When a battery cell is heated above a critical temperature (e.g., above about 150° C) the battery cell can transition into a thermal runaway. Generally, temperatures outside of the safe region on either the low or high side may lead to irreversible damage to the battery cell and, therefore, may possibly trigger thermal runaway. Thermal runaway may also occur due to an internal or external short circuit of the battery cell or poor battery maintenance. For example, overcharging or rapid charging may lead to thermal runaway.

During thermal runaway, the failed battery cell may reach a temperature exceeding about 700° C. Further, large quantities of hot gas are ejected from inside of the failed battery cell through a venting opening in the cell housing into the battery pack. The main components of the vented gas are H₂, CO₂, CO, electrolyte vapor, and other hydrocarbons. The vented gas is, therefore, flammable and potentially toxic. The vented gas also causes a gas-pressure buildup inside the battery pack. In the worst case, the high temperatures lead to the process spreading to neighboring cells and fire in the battery pack. At this stage, the fire is difficult to extinguish.

The BMS is critical to the safe operation and optimal performance of rechargeable battery cells and helps reduce the possibility of thermal runaway. For example, if the BMS detects that the temperature is too high, it can regulate the temperature by controlling cooling fans. Alternatively, if the battery cell cannot be cooled and safe conditions restored, the BMS may shut down battery cells to protect the entire system.

Conventionally, battery cells are cooled by bottom cooling. For example, in conventional battery module designs, a bottom side of the battery cells is cooled to cool the battery cells. To prevent thermal propagation in such battery modules, cell spacers are used to increase the distance between adjacent battery cells. The cell spacers typically have a thickness in a range of about 3 mm to about 4 mm.

However, usage of such cell spacers having a thickness in a range of about 3 mm to about 4 mm decreases the energy density of the battery module up to about 10% in comparison to a similar battery module omitting such cell spacers.

### SUMMARY

Embodiments of the present disclosure provide an alternative design of a battery module that allows for an increase of the battery module’s energy density in comparison to the above-describe conventional battery module design. Embodiments of the present disclosure also reduce the manufacture costs compared to the conventional design. Embodiments of the present disclosure also provide a method for controlling a battery module according to a design that allows for an increase of the battery module’s energy density in comparison to the above-described conventional battery module design.

Embodiments of the present disclosure provide a battery module that allows for an increase of the battery module’s energy density in comparison to a conventional battery module design, and which also reduces manufacture costs in comparison to the conventional design. Embodiments of the present disclosure also provide a method for controlling a battery module that allows for an increase of the battery module’s energy density in comparison to the conventional battery module design.

The present disclosure is defined by the appended claims and their equivalents. The description that follows is subject to this limitation. Any disclosure lying outside the scope of the claims and their equivalents is intended for illustrative as well as comparative purposes.

According to an embodiment of the present disclosure, a battery module includes: a battery cell stack including a plurality of battery cells stacked along a first direction; a plastic cooling plate configured to guide a coolant; a pump; and a controller. Each of the plurality of battery cells is in thermal contact with the plastic cooling plate, and the plastic cooling plate includes a plastic material configured to melt in response to thermal contact with a battery cell affected by a thermal run-away. T controller configured to detect a situation in which at least one of the plurality of battery cells is affected by a thermal run-away and to control, after detection of a thermal run-away in the at least one of the plurality of battery cells, the pump such that the coolant is guided through the plastic cooling plate at a flow rate increased in comparison to a flow rate before the detection of the thermal run-away.

Another embodiment of the present disclosure relates to a battery system including one or more battery modules as described above.

Another embodiment of the present disclosure relates to a vehicle including at least one battery module as described above and/or a battery system as described above.

Another embodiment of the present disclosure relates to a method for controlling a battery module as described above. The method includes detecting, by the controller, whether or not at least one of the plurality of battery cells is affected by a thermal run-away and after detection of a thermal run-away, controlling the pump such that the coolant is guided through the plastic cooling plate at a flow rate increased in comparison to a flow rate before the detection of the thermal run-away.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings in which:

FIG. 1 is a schematic perspective view of a conventional battery cell.

FIG. 2 is a schematic top view of a battery module according to an embodiment of the present disclosure.

FIG. 3 is a schematic top view of a battery module according to another embodiment of the present disclosure.

FIG. 4 is a schematic cross-sectional view of a plastic cooling plate according to an embodiment of the present disclosure.

FIG. 5 is a schematic cross-sectional view of a plastic cooling plate according to another embodiment of the present disclosure.

FIG. 6 is a schematic top view of a battery module according to another embodiment of the present disclosure.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described. In the drawings, the relative sizes of elements, layers, and regions may be exaggerated for clarity.

As used herein, the term "and/or" includes any and all combinations of one or more of the associated listed items. Further, the use of “may” when describing embodiments of the present disclosure refers to “one or more embodiments of the present disclosure." In the following description of embodiments of the present disclosure, the terms of a singular form may include plural forms unless the context clearly indicates otherwise.

It will be understood that although the terms "first" and "second" are used to describe various elements, these elements should not be limited by these terms. These terms are only used to distinguish one element from another element. For example, a first element may be named a second element and, similarly, a second element may be named a first element, without departing from the scope of the present disclosure. As used herein, the term “and/or” includes any and all combinations of one or more of the associated listed items. Expressions such as “at least one of,” when preceding a list of elements, modify the entire list of elements and do not modify the individual elements of the list. For example, the expression "at least one of a, b, or c" indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

As used herein, the term "substantially," "about," and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/- 5% of the value centered on the value.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Herein, the terms “upper” and “lower” are defined according to the z-axis. For example, the upper cover is positioned at the upper part of the z-axis, whereas the lower cover is positioned at the lower part thereof. In the drawings, the sizes of elements may be exaggerated for clarity. For example, in the drawings, the size or thickness of each element may be arbitrarily shown for illustrative purposes, and thus the embodiments of the present disclosure should not be construed as being limited thereto.

In the following description of embodiments of the present disclosure, the terms of a singular form may include plural forms unless the context clearly indicates otherwise.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, for example, on a PCB or another kind of circuit carrier. The conducting elements may include metallization, such as surface metallizations and/or pins, and/or may include conductive polymers or ceramics. Further electrical energy might be transmitted via wireless connections, such as by using electromagnetic radiation and/or light.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like.

Also, a person of skill in the art should recognize that the functionality of various computing devices may be combined or integrated into a single computing device, or the functionality of a particular computing device may be distributed across one or more other computing devices without departing from the scope of the exemplary embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery module includes: a battery cell stack including a plurality of battery cells stacked along a first direction; a plastic cooling plate configured to guide a coolant; a pump; and a controller. Each of the plurality of battery cells is in thermal contact with the plastic cooling plate, and the plastic cooling plate includes (or is made of) a plastic material configured to melt when in thermal contact with a battery cell affected by a thermal run-away. The controller is configured to detect a situation in which at least one of the plurality of battery cells is affected by a thermal run-away and is to control, after detection of a thermal run-away in the at least one of the plurality of battery cells, the pump such that, for a battery cells affected by the thermal run-away, the coolant is guided through the plastic cooling plate in thermal contact with the battery cell or, for the plastic cooling plate in thermal contact with the battery cell, a flow rate of the coolant guided through the plastic cooling plate is increased in comparison to a flow rate before the detection of the thermal run-away.

In one embodiment, the controller is configured to control the pump such that, after detection of a thermal run-away in the at least one of the plurality of battery cells, the flow of coolant guided through the plastic cooling plate is stopped for a time interval or a flow rate of the coolant guided through the plastic cooling plate is decreased for a time interval.

In one embodiment, each of the plurality of battery cells has a prismatic shape. If the number of battery cell stacks is greater than one, the battery cell stacks may be arranged in parallel to each other along the first direction. The plastic cooling plate may extend perpendicular to the first direction. Each of the battery cell stacks may be crossed (or intersected) by the plastic cooling plate.

In one embodiment, each of the battery cells has main sides, and at least one of the main sides abuts the plastic cooling plate.

In one embodiment, each of the battery cells is sandwiched between two plastic cooling plates.

In one embodiment, the battery cells stack has an even number of N battery cells grouped into N / 2 pairs of adjacent battery cells, and each of the N / 2 pairs of adjacent battery cells is sandwiched between two of the plastic cooling plates.

In one embodiment, the plastic cooling plates has a hollow main body formed of two half-plates including a first material comprising plastic.

In one embodiment of the battery module, the two half-plates each have a peripheral edge area and are sealed together along their peripheral edge areas to form the hollow main body.

In one embodiment of the battery module, at least one of the two half-plates has a structure for guiding the coolant and for transferring compressive forces between the two half-plates.

In one embodiment, the hollow main body includes an inlay overmolded by the first material of the two half-plates. The inlay may include a second material different from the first material.

In one embodiment, the second material has a higher thermal conductivity than the first material and/or the second material has a higher heat resistance than the first material.

According to another embodiment, a battery module includes: a battery cell stack including a plurality of battery cells stacked along a first direction; a plastic cooling plate configured to guide a coolant; a pump; and a controller. Each of the battery cells is in thermal contact with the plastic cooling plate, and the plastic cooling plate includes (or is made of) a plastic material configured to melt when it comes into thermal contact with a battery cell affected by a thermal run-away. The controller is configured to detect a situation in which at least one of the battery cells is affected by a thermal run-away and to control, after detection of a thermal run-away in the at least one of the battery cells, the pump such that, for each of the battery cells affected by the thermal run-away, coolant is guided at least through the plastic cooling plate in thermal contact with the battery cell or, for the plastic cooling plate in thermal contact with the battery cell, a flow rate of the coolant guided through the plastic cooling plate is increased in comparison to a flow rate before the detection of the thermal run-away.

Compared to a conventional battery module design as described above in the introductory part of the present disclosure, the battery module according to embodiments of the present disclosure is less costly and provides higher cooler integration flexibility.

In the case of a thermal run-away of one or more of the battery cells, the plastic cooler plates adjacent to the battery cells affected by the thermal run-away are heated by the heat generated within these battery cells due to the thermal run-away. Because the plastic cooling plate is made of or at least includes a plastic material configured to melt when the plastic material comes into thermal contact with a battery cell affected by a thermal run-away, the corresponding plastic cooling plates melt through due to the heat transferred from adjacent battery cells undergoing a thermal run-away. For example, the wall of the plastic cooler plates dissolves or disintegrates in regions adjacent to the failed battery cells. Hence, after this process, coolant guided through the plastic cooling plates comes into direct contact with the battery cells affected by a thermal run-away and provides an optimal cooling effect on the affected battery cells and extinguishes the thermal run-away occurring in the failed battery cells.

When the coolant comes into direct contact with an affected battery cell, the coolant escaping from the plastic cooling plates through the melted areas may also enter into the interior of the battery cell, for example, by entering through the battery cell venting opening or through openings in the battery cell’s case that have been formed due to melting processes of the battery cell caused by the thermal run-away. In such cases, the interior of the affected battery cells may be flooded with coolant.

By using a plastic material for some or all of the cooling plates, manufacture costs are reduced in comparison to conventional cooling plates, which are typically made of metal.

In embodiments, each of the plastic cooling plates is made of or at least includes a plastic material configured to melt when the plastic material comes into thermal contact with a battery cell affected by a thermal run-away.

In embodiments, at least one of the plastic cooling plates is made of a plastic material having a melting temperature at or below the temperature range of a thermal run-away. For example, the melting temperature of the plastic material may be in a temperature range of about 150° C to about 300° C. For example, the melting temperature of the plastic material may be about 200° C.

Locally, a battery cell undergoing a thermal runaway can reach temperatures up to about 1400 C. This leads to immediate melting of the housings (e.g., aluminum housings having a melting temperature of approximately 660 C) of the affected battery cells in the corresponding areas as well as to immediate melting of the plastic material (e.g., having a melting temperature of around 200 C) of the plastic cooling plates arranged adjacent to these areas.

In the embodiment, some or all of the plastic cooling plates may be in direct contact with one or more surfaces of the battery cells, that is, no additional layers or coatings are arranged between the plastic cooling plates and the battery cells. This way, the heat exchange between the plastic cooling plates and the battery cells is further improved.

In embodiments, some or all of the plastic cooling plates may be adhered (e.g., glued) to the respective adjacent main sides of the battery cells to improve the mechanical stability of the battery module. In embodiments, gap fillers may be inserted between the main sides of the battery cells and the adjacent plastic cooling plates. In such embodiments, the gap fillers may also be used to adhere the main sides of the battery cells to the adjacent plastic cooling plates.

In embodiments, intermediate layers (e.g., adhesive layers) are provided between the plastic cooling plates and the battery cells, and the intermediate layers may be configured such that the intermediate layers melt when in thermal contact with a battery cell affected by a thermal run-away.

The expression “plastic cooling plate” as used above in the description of the battery module and as used below could be replaced simply by “cooling plate.” However, to make the term more intelligibly, the term “plastic cooling plate” has been chosen.

The expression “coolant” refers to a cooling liquid, such as water.

In embodiments, electrically non-conducting coolants may be used to prevent short circuits if coolant enters or comes into contact with the failed battery cells after the plastic cooling plates having melted in regions adjacent to the failed battery cells. However, such short circuits do not lead to a major problem. Hence, in embodiments, conductive coolants, such as water, may be employed. Conductive coolants, such as water, are typically less expensive in comparison to electrically non-conducting coolants.

In embodiments, the battery module includes temperature sensors to detect an occurrence of a thermal run-away in the one or more battery cells. The temperature sensors may be attached to the battery cells. In embodiments, one temperature sensor may be provided per battery cell. In embodiments, the battery cells may be grouped into groups of multiple battery cells (e.g., pairs each including two battery cells), and one temperature sensor may be provided per group.

In embodiments, the battery module includes pressure sensors to detect an occurrence of a thermal run-away in the one or more battery cells. Each of the pressure sensors may be arranged within the interior of a battery cell housing. In embodiments, each battery cell may be equipped with a pressure sensor.

In embodiments, the battery module includes voltage sensors and/or current sensors to detect an occurrence of a thermal run-away in the one or more battery cells. In embodiments, each battery cell may be equipped with a voltage sensor and/or current sensor.

In the afore-mentioned embodiments, signals generated by the temperature sensors, the pressure sensors, the voltage sensors, and/or the current sensors may be transmitted to a controller, which is configured to evaluate the signals and to detect, based on these signals, whether or not a thermal runaway is occurring in the battery module.

In one embodiment of the battery module, the controller is configured to control the pump such that, after detection of a thermal run-away in at least one of the battery cells, the flow of coolant guided through the plastic cooling plates is stopped for a time interval or a flow rate of the coolant guided through the plastic cooling plates is decreased for a time interval.

In one embodiment of the battery module, the controller is configured to control the pump such that, after detection of a thermal run-away in at least one of the battery cells, for each of the battery cells affected by the thermal run-away and for at least one plastic cooling plate in thermal contact with the battery cell, the flow of coolant guided through the plastic cooling plate is stopped for a time interval or a flow rate of the coolant guided through the plastic cooling plate is decreased for a time interval.

The effect of stopping, for a time interval, the flow of coolant guided through one or more plastic cooling plates in thermal contact with a battery cell affected by a thermal run-away is that cooling effect provided by these plastic cooling plates on the battery cell is stopped or interrupted for the time interval. As a consequence, the cooling plates in thermal contact with a battery cell affected by a thermal run-away are heated more quickly due to the heat generated by the thermal run-away in the adjacent affected battery cell such that the melting of the plastic material is accelerated and/or the reliability of this melting effect is enhanced.

However, the flow of coolant may not be completely stopped but only reduced. The effect of reducing, for a time interval, the flow rate of coolant guided through one or more plastic cooling plates in thermal contact with a battery cell affected by a thermal run-away is that the cooling effect provided by these plastic cooling plates on the battery cell is also reduced for the time interval. As a consequence, the cooling plates being in thermal contact with a battery cell affected by a thermal run-away are heated more quickly due to the heat generated by the thermal run-away in the adjacent affected battery cell such that the melting of the plastics material is accelerated and/or the reliability of this melting effect is enhanced.

The wording “after detection” may be understood in the present context as “immediately at the time of detection or a certain (e.g., predefined) time interval after detection.”

In one embodiment of the battery module, each of the battery cells has a prismatic shape, and the battery cells are arranged in at least one battery cell stack.

In one embodiment of the battery module, if the number of battery cell stacks is greater than one, the battery cell stacks are arranged in parallel to each other along the first direction, each of the plastic cooling plates extends perpendicular to the first direction, and each of the battery cell stacks is crossed (or intersected) by at least one of the plastic cooling plates.

Because, according to the afore-described embodiments, each of the plastic cooling plates extends perpendicular to the first direction, the plastic cooling plates are all arranged in parallel to each other.

In one embodiment of the battery module, each of the battery cells includes main sides, and at least one of the main sides abuts at least one of the plastic cooling plates.

In comparison to the conventional bottom cooling battery module design as described above in the introductory part of the present disclosure, the afore-described embodiments provide a cooling area that is increased by a factor of up to 10.

Further, expensive cell spacers inserted in between the battery cells may be omitted.

Due to the geometry of the stack, between any two neighboring plastic cooling plates, when viewing along one of the battery cell stacks, either a single battery cell of this battery cell stack is sandwiched between these two neighbored plastic cooling plates (in this case, either of the main sides of this battery cell can be cooled by the plastic cooling plates) or a pair of adjacent battery cells of this battery cell stack is sandwiched between these two neighbored plastic cooling plates (in this case, for each of these battery cells, only one of the main sides can be cooled by the plastic cooling plates).

In one embodiment of the battery module, each of the battery cells is sandwiched between two plastic cooling plates.

In one embodiment of the battery module, each of the battery cells stacks includes an even number of N battery cells being grouped into N / 2 pairs of adjacent battery cells, and each of the N / 2 pairs of adjacent battery cells is sandwiched between two plastic cooling plates.

In one embodiment of the battery module, each of the plastic cooling plates crosses or intersects each of the battery cell stacks.

In one embodiment, the battery module further includes an inlet channel and an outlet channel, the inlet channel is fluidly connected with each of the plastic cooling plates, and the outlet channel is fluidly connected with each of the plastic cooling plates.

Here, the term “fluidly connected” refers to a connection between two pipes or channels that facilitates the smooth exchange of fluid between them, ensuring uninterrupted flow and communication.

In the afore-described embodiments, the inlet channel and the outlet channel may be placed such that each of the battery cell stacks is arranged between the inlet channel and the outlet channel. Then, a flow of coolant from the inlet channel, via the plastic cooling plates, to the outlet channel would cross each of the battery cell stacks and, thus, provide a good cooling effect on each of the battery cell stacks.

The inlet channel may be fluidly connected with a first reservoir providing “fresh” coolant, that is, coolant having a temperature (e.g., a temperature in the range of about −40 C to about +55 C) suitable for cooling the battery cells. The outlet channel may be fluidly connected with a second reservoir, into which the used coolant (e.g., coolant that has flowed through the plastic cooling plates) can be discharged. The coolant discharged into the second reservoir can be cooled by a cooling device, transferred into the first reservoir again, and then be used as “fresh” again.

To move “fresh” coolant into the inlet channel, a pump may be arranged between the first reservoir and an inlet of the inlet channel. Alternatively or additionally, another pump may be arranged between an outlet of the outlet channel and the second reservoir to discharge the used coolant out of the outlet channel.

In other embodiments, only a single reservoir may be used, from which coolant is sought into the inlet channel and into which coolant is discharged from the outlet channel. In those embodiments, the single reservoir may be cooled by a cooling device.

However, in another embodiment of the battery module, the first and second reservoir may be omitted. Because, in case of a thermal run-away of a single battery cell or a certain group of battery cells, the body of the remaining battery module (containing battery cells not being affected by a thermal run-away) normally represents a very large thermal mass, which is usually sufficient for cooling the affected battery cells, when the coolant is circulating within the cooling system of the battery module.

In one embodiment of the battery module, at least one of the plastic cooling plates includes a hollow main body assembled from two half-plates made of a first material including plastic.

In embodiments, the material of the half-plates is a plastic material.

In embodiments, each of the plastic cooling plates includes a hollow main body assembled from two half-plates.

All or at least one of the half-plates may be designed as an essentially flat plane having an indentation or depression (forming a major part of the half-plate) and a peripheral edge area surrounding (e.g., extending around) the indentation or depression.

In one embodiment of the battery module, the two half-plates each includes a peripheral edge area and are sealed together along their peripheral edge areas.

In embodiments, for all main bodies, the two half-plates each include a peripheral edge area and are sealed together along their peripheral edge areas.

In embodiments, for at least main body, the two half-plates may be sealed together by hot-plate welding. In one or more embodiments, for each of the main bodies, the two half-plates may be sealed together by hot-plate welding.

In one embodiment of the battery module, for at least one of the main bodies, at least one of the two half-plates include a structure for guiding the coolant and for transferring compressive forces between the two half-plates.

These compressing forces, also referred to as swelling forces, may occur when the battery cells swell during use.

By transferring compressive forces between the two half-plates, the transferring forces are transferred between two sides of the plastic cooling plate including the main body.

In one embodiment of the battery module, at least one of the main bodies includes an inlay overmolded by the first material of the half-plates, and the inlay includes a second material different from the first material.

The second material may be a plastic material or may include a plastic material.

In one embodiment of the battery module, the second material includes a higher thermal conductivity than the first material and/or the second material has a higher heat resistance than the first material.

In embodiments in which the second material has a higher heat resistance than the first material, the second material may include MICA or glass fibers.

According to embodiments of the present disclosure, the cooling effect in the case of a thermal run-away occurring in one or more of the battery cells is improved. In case of a thermal run-away in one or more of the battery cells, the controller (which may be integrated in the BMS) will switch on the cooling system. This will start to cool the battery cells affected by the thermal run-away and will also cool and protect the neighboring battery cells.

In case of a local melting of a plastic cooler plate in regions at where the plastic cooler plate adjoins the battery cell undergoing a thermal run-away, coolant (e.g., cooling water) will be directly spilled over adjacent very hot surfaces of the battery cells, which provides very focused and effective cooling.

Another embodiment of the present disclosure relates to a battery system including one or more battery modules as described herein.

Another of the present disclosure relates to a vehicle including at least one battery module as described herein and/or at least one battery system as described herein.

The vehicle may be a hybrid vehicle or a fully electric vehicle.

Another of the present disclosure relates to a method of controlling a battery module. The method includes: detecting, by the controller, whether or not at least one of the plurality of battery cells is affected by a thermal run-away; and after detection of a thermal run-away, controlling the pump such that, for a battery cell affected by the thermal run-away, the coolant is guided through the plastic cooling plates in thermal contact with the battery cell or, for the plastic cooling plate in thermal contact with the battery cell, a flow rate of the coolant guided through the plastic cooling plate is increased in comparison to a flow rate before the detection of the thermal run-away.

In one embodiment, the method further comprises, after detection of a thermal run-away and before the controlling of the pump, controlling the pump such that the flow of coolant guided through the plastic cooling plate is stopped for a time interval or a flow rate of the coolant guided through the plastic cooling plate is decreased for a time interval. Another embodiment of the present disclosure is related to a method of controlling a battery module including: detecting, by a controller, whether or not at least one of the battery cells is affected by a thermal run-away; after detection of a thermal run-away, controlling a pump such that, for each of the battery cells affected by the thermal run-away, coolant is guided at least through one of the plastic cooling plates in thermal contact with the battery cell or, for at least one plastic cooling plate in thermal contact with the battery cell, a flow rate of the coolant guided through the plastic cooling plate is increased in comparison to a flow rate before the detection of the thermal run-away.

In one embodiment, the method further includes, after detection of a thermal run-away and before the controlling the pump, controlling the pump such that the flow of coolant guided through the plastic cooling plates is stopped for a time interval or a flow rate of the coolant guided through the plastic cooling plates is decreased for a time interval.

In one embodiment, the method further includes after detection of a thermal run-away and before the controlling the pump, controlling the pump such that, for each of the battery cells affected by the thermal run-away, for at least one plastic cooling plate in thermal contact with the battery cell, the flow of coolant guided through the plastic cooling plate is stopped for a time interval or a flow rate of the coolant guided through the plastic cooling plate is decreased for a time interval.

The effect of stopping or reducing, for a time interval, the flow of coolant guided through one or more plastic cooling plates in thermal contact with a battery cell affected by a thermal run-away has been already described above, and that description applies correspondingly to the afore-described embodiment of the method for controlling a battery module.

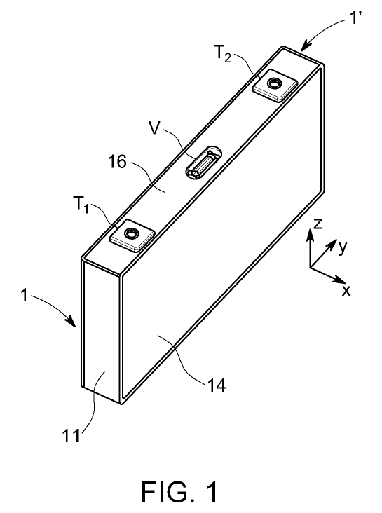

A battery module or battery system generally includes one or more battery cell stacks. The individual battery cells in one of those stacks are generally shaped identically or essentially identically to each other. As an example, the design of a typical battery cell 1 used in a battery cell stack is schematically illustrated in FIG. 1, with reference to a Cartesian coordinate system, in a perspective view. The illustrated battery cell 1 has a parallelepiped (e.g., prismatic) shape essentially defined by a case 1’. The case 1’ is, for example, a hardcase, which may be made of, for example, a metal material. The case 1’ may also have a can shape or a barrel shape including six essentially planar outer side faces. The case 1’ in FIG. 1 includes a pair of congruent main sides (of that pair, only the main side 14 facing into the x-direction is visible in FIG. 1) arranged opposite to each other. Each of the main sides is perpendicular to the x-axis. The case 1’ also includes a lower side (not visible in FIG. 1) and an upper side 16. The lower side and the upper side 16 are congruent and arranged opposite to each other, and each of the lower side and the upper side 16 are perpendicular to the z-axis. The case 1’ also includes a pair of congruent lateral sides (of this pair, only the side 11 facing against the y-direction is visible) arranged opposite to each other. Each of the third lateral sides is perpendicular to the y-axis. As can be seen in FIG. 1, the main sides of the battery cell 1 form the battery cell’s sides having the largest (or maximal) surface.

A first terminal T₁ and a second terminal T₂ are arranged on the upper side 16 of the battery cell 1. Accordingly, the upper side 16 will be referred to herein as the “terminal side” of the battery cell 1. The terminals and T₁, T₂ allow for an electrical connection (e.g., an external electrical connection) of the battery cell 1. The first terminal T₁ may be the positive terminal of the battery cell 1, and the second terminal T₂ may be the negative terminal of the battery cell 1. However, the opposite is also possible. Furthermore, a venting outlet V is arranged on the upper side 16 between the first terminal T₁ and the second terminal T₂. Venting gas can be ejected from the battery cell 1 through the venting outlet V in case of a thermal event occurring in the battery cell 1, such as thermal run-away. Inside the battery cell 1, a valve is often installed upstream of the venting outlet V. The valve is configured to open (e.g., to burst) when the gas pressure inside the battery cell exceeds a reference (or predefined) value and to remain in a closed stated otherwise, such as when the gas pressure inside the battery cell is below the reference value. Thus, before being emitted (or output) via the venting outlet V, the venting gas passes through the venting valve arranged inside the battery cell 1.

By stacking a plurality of battery cells together, each being designed as (or similar to) the battery cell 1 shown in FIG. 1 along a first direction, a stack of battery cells (hereinafter referred to as the “battery cell stack” or simply as the “stack”) is formed. For example, the first direction (hereinafter referred to as the “stack direction”) may correspond to a direction parallel to the x-axis of the coordinate system shown in FIG. 1. Any one of the individual battery cells 1 may be oriented in the stack such that its main sides each extend perpendicular to the x-axis. Typically, a plurality of battery cell stacks is used in (or is included in) a battery module. In a battery cell stack, neighboring battery cells may either directly abut against each other or be spaced apart from each other by cell spacers. Cell spacers can be used (or included) to adjust the overall length of a stack. Furthermore, cell spacers (also referred to as “gap fillers”) can be configured to inhibit or at least reduce thermal propagation along the stack (e.g., between battery cells in the stack), for example, in view of the heat generated during a thermal run-away. One or more battery cell spacers may be combined in (or included in) a battery cell stack.

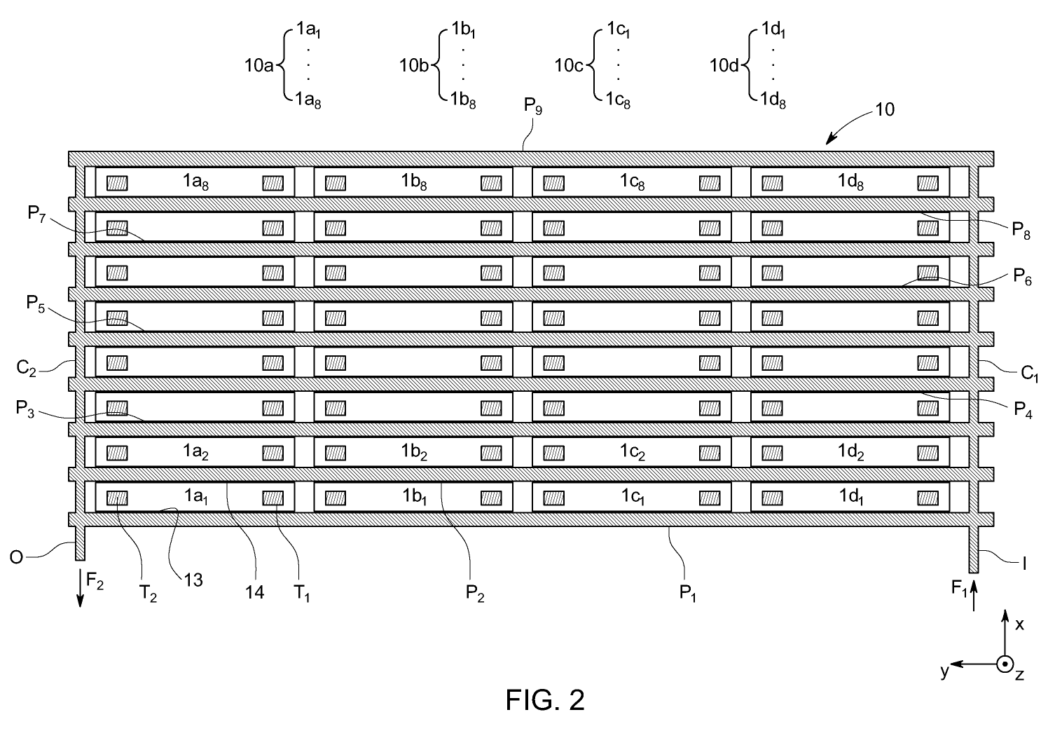

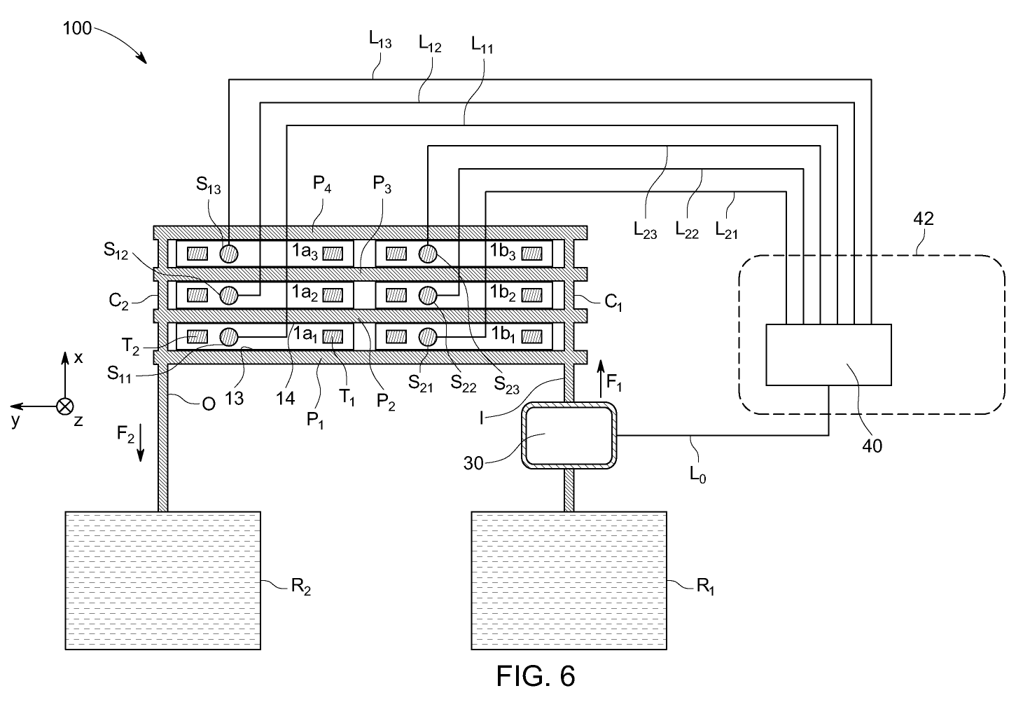

FIG. 2 is a top view of a battery module 10 according to an embodiment of the present disclosure. The battery module 10 illustrated in FIG. 2 includes four battery cell stacks 10a, 10b, 10c, 10d as an example. Each of the stacks includes eight battery cells as an example. For example, the first battery cell stack 10a includes the battery cells 10a₁, …, 10a₈ aligned along the x-direction. The second stack 10b, the third stack 10c, and the fourth stack 10d have a similar arrangement of battery cells. Only the first, second, and last battery cell stack in each stack are labelled in FIG. 2 to keep the drawing clear. Each of the battery cells 1a₁, 1a₂, …, 1a₈, 1b₁, 1b₂, …, 1b₈, 1c₁, 1c₂, …, 1c₈, 1d₁, 1d₂, …, 1d₈ may have a design similar to that of the battery cell 1 shown in FIG. 1 and includes a first terminal T₁ and a second terminal T₂. The venting outlets V are not shown in FIG. 2 for the sake of simplicity. Also, a controller, temperature sensors, and a pump, which may be included in the battery module 10, are omitted in FIG. 2 to keep the figure simple. The functioning of the controller, the temperature sensors, and the pump will be described later with reference to FIG. 6.

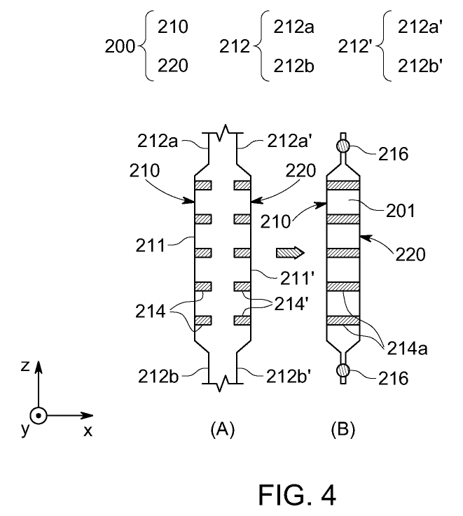

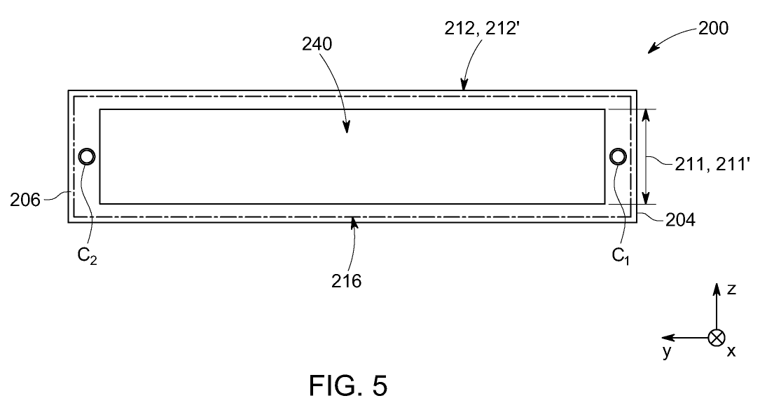

The battery module 10 according to the embodiment shown in FIG. 2 further includes a cooling system including a plurality of cooling plates P₁, P₂, P₃, P₄, P₅, P₆, P₇, P₈, P₉, as well as an inlet channel C₁ and an outlet channel C₂. Each of the cooling plates P₁, …, P₉ has a hollow body extending parallel to the y-z-plane of the coordinate system perpendicular to x-axis, that is, perpendicular to the stack direction of each of the stacks 10a, 10b, 10c, 10d. Further, the bodies of each of the cooling plates P₁, …, P₉are madeof a plastic material having a melting point at or below the temperature range of typically generated by a battery cell experiencing thermal run-away (e.g., a temperature range of about 400 C to about 1400 C). For example, the melting point of the plastic material may be in a temperature range of about 150° C to about 300° C. For example, the melting point of the plastic material may be a temperature of about 200 C. The cooling plates P₁, …, P₉will be referred to hereinafter as “plastic cooling plates.” The design of the plastic cooling plates P₁, …, P₉will be explained in more detail below with reference to FIGS. 4 and 5.

Both, the inlet channel C₁ and the outlet channel C₂ are formed as pipes in fluid communication with each of the plastic cooling plates P₁, …, P₉. The inlet channel C₁ includes an inlet I that can be connected with a first reservoir providing “fresh” coolant, that is, coolant having a temperature suitable for cooling the battery cells. For example, the “fresh” coolant may have a temperature in the range of about −40 C to about +55 C. Further, the outlet channel C₂ includes an outlet O that can be connected with a second reservoir into which used coolant (e.g., coolant that has flowed through the plastic cooling plates) can be discharged. The coolant discharged into the second reservoir can be cooled, transferred to the first reservoir, and then be (re)used as “fresh” coolant. To move “fresh” coolant into the inlet channel (indicated by the arrow F₁), a pump may be arranged between the first reservoir and the inlet I. Alternatively or additionally, a pump may be arranged between the outlet O and the second reservoir to discharge the used coolant out of the outlet channel (indicated by the arrow F₂).

As each of the plastic cooling plates P₁, …, P₉ fluidly communicates with the inlet channel C₁ as well as with the outlet channel C₂, coolant can be guided through each of the plastic cooling plates P₁, …, P₉.

In the embodiment of the battery module as illustrated in FIG. 2, the arrangement of the battery cells 1a₁, …, 1a₈, 1b₁, …, 1b₈, 1c₁, …, 1c₈, 1d₁, …, 1d₈ with respect to the plastic cooling plates P₁, …, P₉ can be described as follows. A first plastic cooling plate P₁ is arranged, when viewing into the x-direction, in front of the first battery cells 1a₁, 1b₁, 1c₁, 1d₁ of each of the battery cell stacks 10a, 10b, 10c, 10d. The first plastic cooling plate P₁ extends parallel to the y-z-plane of the coordinate system (e.g., orthogonal to the drawing plane of FIG. 2) and, thereby, abuts against the main sides facing against the x-direction of any one of the first battery cells 1a₁, 1b₁, 1c₁, 1d₁ such that these main sides are each completely covered or at least a major part of each of these main sides is covered by the first plastic cooling plate P₁.

Similarly, a last plastic cooling plate P₉ is arranged, when viewing into the x-direction, behind the last battery cells 1a₈, 1b₈, 1c₈, 1d₈ of each of the battery cell stacks 10a, 10b, 10c, 10d. The last plastic cooling plate P₉ extends parallel to the y-z-plane of the coordinate system and, thereby, abuts against the main sides facing into the x-direction of any one of the last battery cells 1a₈, 1b₈, 1c₈, 1d₈ such that these main sides are each completely covered or at least a major part of each of these main sides is covered by the last plastic cooling plate P₉.

Because each of the battery cell stacks 10a, 10b, 10c, 10d is confined by the first plastic cooling plate P₁ and the last plastic cooling plate P₉ with respect to the x-direction, these two plastic cooling plates P₁, P₉ will be referred to hereinafter as the “outer plastic cooling plates” in the context of this embodiment. In contrast thereto, each of the remaining plastic cooling plates P₂, P₃, P₄, P₅, P₆, P₇ will be referred to as the “inner plastic cooling plates” in the context of this embodiment.

Any one of the inner plastic cooling plates P₂, P₃, P₄, P₅, P₆, P₇ crosses or intersects each of the four battery cell stacks 10a, 10b, 10c, 10d. For each of the stacks 10a, 10b, 10c, 10d. For example, the second plastic cooling plate P₂ is arranged, when viewing into the x-direction, between the first battery cell and the second battery cell of the respective stack. For example, with respect to the first battery cell stack 10a, the second plastic cooling plate P₂ is arranged, when viewing into the x-direction, between the first battery cell 10a₁ and the second battery cell 10a₂ of the first battery cell stack 10a. This arrangement applies in a corresponding manner for the remaining stacks 10b, 10c, 10d. Further, the second plastic cooling plate P₂ extends parallel to the y-z-plane of the coordinate system and abuts against the main sides facing into the x-direction of any one of the first battery cells 1a₁, 1b₁, 1c₁, 1d₁ of the stacks 10a, 10b, 10c, 10d and also against the main sides facing against the x-direction of any one of the second battery cells 1a₂, 1b₂, 1c₂, 1d₂ of the stacks 10a, 10b, 10c, 10d such that these main sides are each completely covered or at least a major part of each of these main sides is covered by the second plastic cooling plate P₂. The remaining inner plastic cooling plates P₃, P₄, P₅, P₆, P₇ are arranged in a corresponding manner.

In the afore-described embodiment, each of the individual battery cells 1a₁, …, 1a₈, 1b₁, …, 1b₈, 1c₁, …, 1c₈,1d₁, …, 1d₈ is sandwiched between two neighboring (or adjacent) plastic cooling plates as shown in FIG. 2. Thus, the plastic cooling plates P₁, P₂, P₃, P₄, P₅, P₆, P₇, P₈, P₉ each abut against the main sides of the individual battery cells (e.g., the sides having the largest surface or surface area). Hence, upon guiding coolant through the plastic cooling plates P₁, …, P₉, optimal heat exchange occurs between the coolant and each of the battery cells. In this embodiment, the plastic cooling plates P₁, …, P₉ may be in direct contact with the battery cell’s main sides (e.g., no additional layers or coatings are between the plastic cooling plates and the battery cells, except, in some embodiments, adhesive layers), which further improves the heat exchange therebetween. However, to improve the mechanical stability of the battery module 10, the plastic cooling plates P₁, …, P₉ may be adhered (e.g., glued) to the respective adjacent main sides of the battery cells. In other embodiments, gap fillers may be inserted between the main sides of the battery cells and the adjacent plastic cooling plates. In such embodiments, the gap fillers may be used to adhere the main sides of the battery cells to the adjacent plastic cooling plates.

The material of the plastic cooler plates P₁, …, P₉ is optimized to have sufficient thermal conductivity. With a plastic material having excellent thermal conductivity characteristics and the increased surface contact between the cooler plates and the main sides of the battery cells, the heat dissipation from the battery cells is improved.

Gap fillers may have a thermal conductivity of approximately 0.6 W m⁻¹ K⁻¹. When the plastic cooling plates have a plastic thickness of 1.5 mm, the same conductivity (e.g., thermal conductivity) across the areas of the plastic cooling plates that are in thermal contact with the battery cells is desired. Thus, a design goal is to reduce or minimize the plastic thickness, which reduces the amount of thermal conductive plastic material necessary.

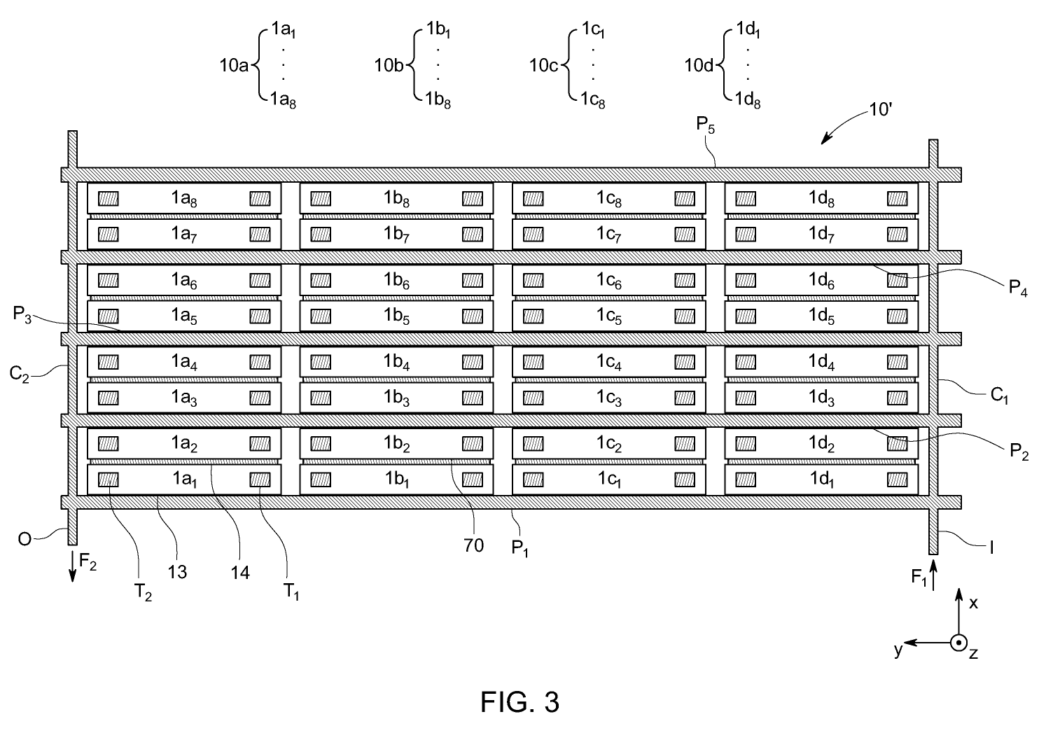

FIG. 3 is a top view of a battery module 10’ according to another embodiment of the present disclosure. Except for the space required for the plastic cooling plates, the arrangement of the battery cells 1a₁, 1a₂, …, 1a₈, 1b₁, 1b₂, …, 1b₈,1c₁, 1c₂, …, 1c₈, 1d₁, 1d₂, …, 1d₈ in this embodiment is similar to that of the embodiment as described above with reference to FIG. 2. The battery module 10’ includes four battery cell stacks 10a, 10b, 10c, 10d. Each of these stacks includes eight battery cells aligned along the x-direction. Each of the battery cells 1a₁, …, 1d₈ may have a design similar to that of the battery cell 1 shown in FIG. 1. Similar to FIG. 2, the venting outlets V are not shown in FIG. 3 to keep the drawing simple. Also, a controller, temperature sensors, and a pump, which may be included in the battery module 10’, are omitted from the drawing for the sake of simplicity. The functioning of the controller, the temperature sensors, and the pump will be described later with reference to FIG. 6.

The battery module 10’ shown in FIG. 3 further includes a cooling system including a plurality of plastic cooling plates P₁, P₂, P₃, P₄, P₅, as well as an inlet channel C₁ and an outlet channel C₂. The appearance of the plastic cooling plates P₁, …, P₅ and the channels C₁, C₂ correspond to that described above with reference to FIG. 2. Also, elements for guiding a coolant through the plastic cooling plates P₁, …, P₅and the channels C₁, C₂ may correspond to these described above with reference to FIG. 2, including the one or more pumps and the reservoirs. Further details as to the design of the plastic cooling plates P₁, …, P₅will be provided below with reference to FIGS. 4 and 5.

Different from the embodiment illustrated in FIG. 2, the battery module 10’ shown in FIG. 3 includes fewer (e.g., only five) plastic cooling plates P₁, …, P₅. A first plastic cooling plate P₁ is arranged, when viewing into the x-direction, in front of the first battery cells 1a₁, 1b₁, 1c₁, 1d₁ of each of the battery cell stacks 10a, 10b, 10c, 10d. The first plastic cooling plate P₁ extends parallel to the y-z-plane of the coordinate system (e.g., orthogonal to the drawing plane of FIG. 3) and, thereby, abuts against the main sides facing against the x-direction of any one of the first battery cells 1a₁, 1b₁, 1c₁, 1d₁ such that these main sides are each completely covered or at least a major part of each of these main sides is covered by the first plastic cooling plate P₁.

Similarly, a last plastic cooling plate P₅ is arranged, when viewing into the x-direction, behind the last battery cells 1a₈, 1b₈, 1c₈, 1d₈ of each of the battery cell stacks 10a, 10b, 10c, 10d. The last plastic cooling plate P₅ extends parallel to the y-z-plane of the coordinate system and, thereby, abuts against the main sides facing into the x-direction of any one of the last battery cells 1a₈, 1b₈, 1c₈, 1d₈ such that these main sides are each completely covered or at least a major part of each of these main sides is covered by the last plastic cooling plate P₅.

Because of the battery cell stacks 10a, 10b, 10c, 10d is confined by the first plastic cooling plate P₁ and the last plastic cooling plate P₅ in the x-direction, these two plastic cooling plates P₁, P₅ will be referred hereinafter as the “outer plastic cooling plates” in this embodiment. In contrast thereto, each of the remaining plastic cooling plates P₂, P₃, P₄ will be referred to as the “inner plastic cooling plates” in this embodiment.

In each of the battery cell stacks 10a, 10b, 10c, 10d, the respective eight individual battery cells are grouped into pairs of adjacent (or neighboring) battery cells. For example, the battery cells 1a₁, 1a₂, …, 1a₈ of the first stack 10a are grouped into a first pair including the first and second battery cells 1a₁, 1a₂, a second pair including the third and fourth battery cells 1a₃, 1a₄, a third pair including the fifth and sixth battery cells 1a₅, 1a₆, and a fourth pair including the seventh and eighth battery cells 1a₇, 1a₈. The battery cells of the remaining stacks 10b, 10c, 10d are grouped in a corresponding manner as shown in FIG. 3.

In the afore-described pair of battery cells, the two battery cells are separated by a cell spacer 70 for electrical isolation. The cell spacer may be relatively thin. Additionally, the cell spacer may be designed to compensate for tolerances and accumulated swelling forces, respectively.

In the embodiment shown in FIG. 3, the inner plastic cooling plates are arranged such that, in each of the stacks 10a, 10b, 10c, 10d, each of the above-described pairs of battery cells is sandwiched between two plastic cooling plates. For example, each of the first pairs in the battery cells stacks 10a, 10b, 10c, 10d is sandwiched between the first plastic cooling plate P₁ and the second plastic cooling plate P₂. Similarity, each of the second pairs in the battery cells stacks 10a, 10b, 10c, 10d is sandwiched between the second plastic cooling plate P₂ and the third plastic cooling plate P₃. Also, each of the third pairs in the battery cells stacks 10a, 10b, 10c, 10d is sandwiched between the third plastic cooling plate P₃ and the fourth plastic cooling plate P₄. Lastly, each of the fourth pairs in the battery cells stacks 10a, 10b, 10c, 10d is sandwiched between the fourth plastic cooling plate P₄ and the fifth (e.g., last) plastic cooling plate P₅.

Thus, different from the embodiment described above with reference to FIG. 2, in which the main sides of each battery cell are in thermal contact with a plastic cooling plate, in the present embodiment, only one of the main sides of each battery cell is in thermal contact with a plastic cooling plate. This allows, within the same packaging space as provided by the embodiment shown in FIG. 2, the use of plastic cooling plates having an increased thickness (e.g., double thickness) in comparison to the embodiment shown in FIG. 2. To achieve a similar packaging ratio as designs using cell spacers having a thickness in a range of about 3 to about 4 mm, the embodiment illustrated in FIG. 3 allows for increased wall thickness of the plastic cooling plates.

The embodiment shown in FIG. 2 illustrates a concept in which both main sides of each battery cell is in thermal contact with a plastic cooling plate. The embodiment shown in FIG. 3 illustrates a concept in which only one main side of each battery cell is in thermal contact with a plastic cooling plate but which allows for the use of plastic cooling plates with thicker walls in comparison to the embodiment shown in FIG. 2.

Each of the embodiments described thus far have been described as including eight battery cells per stack, but aspects and features of the present disclosure can be generalized to the employment of N battery cells per stack, where N is an arbitrary natural number according to the embodiment shown in FIG. 2 and an even natural number according to the embodiment shown in FIG. 3. Of course, the number of used battery cell stacks can also be varied. Here, the term “natural numbers” shall refer to the set of positive integer numbers.

For example, when applying the embodiment shown in FIG. 2 with N battery cells, two outer plastic cooling plates are included, viz. a first plastic cooling plate placed before (e.g., in front of) each of the respective first battery cells of each battery cell stack when viewing along a stack direction and a last plastic cooling plate placed behind each of the respective last battery cells of each battery cell stack when viewing along the stack direction. Further, a plastic cooling plate is provided between any two adjacent battery cells in each stack, such that (N – 1) inner plastic cooling plates are included. Hence, according the embodiment shown in FIG. 2, a total number of (N + 1) plastic cooling plates is included.

When applying the embodiment shown in FIG. 3 with N battery cells (N being an even natural number), two outer plastic cooling plates are included, viz. a first plastic cooling plate placed before (e.g., in front of) each of the respective first battery cells of each battery cell stack when viewing along a stack direction and a last plastic cooling plate placed behind each of the respective last battery cells of each battery cell stack when viewing along the stack direction. Further, a plastic cooling plate is provided between any two adjacent pairs of battery cells in each stack, such that (N / 2 – 1) inner plastic cooling plates are included. Hence, according to the embodiment shown in FIG. 3, a total number of (N / 2 + 1) plastic cooling plates is included.

With reference to FIGS. 4 and 5, embodiments of a plastic cooling plates shall are described, which can be used with any of the above-described embodiments and their generalizations to N battery cells per stack as described above. Accordingly, a plastic cooling plate 200 as schematically illustrated in FIGS. 4 and 5 can be employed as any one of the plastic cooling plates P₁, P₂, P₃, P₄, P₅, P₆, P₇, P₈, P₉ of the battery module 10 as described with reference to FIG. 2 or as any one of the plastic cooling plates P₁, P₂, P₃, P₄, P₅ of the battery module 10’ as described with reference to FIG. 3.

As schematically illustrated in FIG. 4, a plastic cooling plate 200 may include a first half-plate 210 and a second half-plate 220. FIG. 4(A) shows a cross-section through the plastic cooling plate 200 in a non-assembled state, while FIG. 4(B) shows a cross-section through the same plastic cooling plate 200 in an assembled state. In the illustrated embodiment, the first half-plate 210 and the second half-plate 220 are symmetrically shaped, for example, the shape of the second half-plate 220 may be obtained by mirroring the shape of the first half-plate 210 on a plane parallel to the y-z-plane of the coordinate system. In various embodiments, the first half-plate 210 and the second half-plate 220 may be shaped identically such that, with reference to FIG. 4(A), the shape of the second half-plate 220 may be obtained by rotating the shape of the first half-plate 210 around an axis parallel to the y-axis of the coordinate system (e.g., perpendicular to the drawing plane of FIG. 4) by an angle of 180°.

Due to the symmetries described above, the details of the half-plates may be described with respect to the first half-plate 210 with the understanding that the same description applied to the second half-plate 220. The first half-plate 210 includes an essentially flat plane having an indentation or depression 211 and a peripheral edge area 212 surrounding (e.g., extending around) the indentation or depression 211. With regard to the coordinate system in FIG. 4, the indentation or depression 211 is convex in the first half-plate 210 into the direction against the x-axis. Referring to FIG. 4(A), which is a cross-section through the plastic cooling plate 200, an upper portion 212a and a lower portion 212b of the peripheral edge area 212 appear separated from each other in the drawing. However, the upper portion 212a and the lower portion 212b merge into another in parts of the first half-plate 210 located below and above the drawing plane of FIG. 4 to form a continuous circumferential peripheral edge area 212 of the first half-plate 210. The corresponding features of the second half-plate 220 are labelled by analogue reference signs in FIG. 4(A) but are indicated by an additional prime.

Further, the first half-plate 210 includes a structure including a plurality of noses (e.g., protrusions) 214, each of the noses 214 protruding from the indentation or depression 211 into the x-direction. When the first half-plate 210 is assembled with the second half-plate 220 to form the plastic cooling plate as depicted in FIG. 4(B), the noses 214 of the first half-plate 210 abut each against respective noses 214’ of the second half-plate 220 to form bridges 214a. These bridges 214a may form a structure for guiding coolant flowing within the interior 201 of the plastic cooling plate 200. Additionally or alternatively, the bridges 214a may form a structure for transferring compressive forces between the two half-plates. The compressive forces may be swelling forces caused by expanding battery cell cases 1’ during use of the battery cells arranged adjacent to the plastic cooling plate 200 in a battery module according to an embodiment of the present disclosure. The bridges 214a may be designed to have a stiffness to provide optimal battery cell lifetime performance and may also act as a tolerance compensation for thickness deviations of the battery cells. The noses 214, 214’ and/or the bridges 214a may be made of a plastic material.

In other embodiments, the noses may be omitted on the second half-plate 220, while the noses 214 of the first half-plate 210 are elongated to form the complete (or entire) bridges 214a when the first half-plate 210 and the second half-plate 220 are assembled to the plastic cooling plate 200 as shown in FIG. 4(B). In some embodiments, some of bridges 214a may be formed as one piece by noses protruding from the first half-plate 210, while other noses are formed as one piece by noses protruding from the second half-plate 220. In the afore-described embodiments, of course, the first half-plate 210 and the second half-plate 220 may no longer be symmetric with respect to the noses.

The bridges 214a may be formed as columns extending, with respect to the x-direction, between the indentation or depression 211 of the first half-plate 210 to the indentation or depression 211’ of the second half-plate 220. In other embodiments, the bridges 214a may be formed as fins extending, with respect to the x-direction, between the indentation or depression 211 of the first half-plate 210 to the indentation or depression 211’ of the second half-plate 220 and each forming a flat structure extending parallel or essentially parallel to the x-y-plane of the coordinate system.

When the first half-plate 210 and the second half-plate 220 as illustrated in FIG. 4(A) are assembled to form the plastic cooling plate 200 as shown in FIG. 4(B), the first half-plate 210 and the second half-plate 220 are attached to each other by (or along) their peripheral edge areas 212, 212’. In the assembled plastic cooling plate 200, the indentation or depression 211 of the first half-plate 210 and the corresponding indentation or depression 211’ of the second half-plate 220 point away from each other. Consequently, a cavity 201 is formed between the first half-plate 210 and the second half-plate 220 in the area of their indentation or depression 211, 211’.

To assemble the plastic cooling plate 200, the first half-plate 210 and the second half-plate 220 may be welded together by, for example, hot-plate welding or mirror welding. In the example shown in FIG. 4, the first half-plate 210 and the second half-plate 220 are welded together at (or along) their peripheral edge areas 212, 212’.

For example, the welding is performed along a welding line 216 running along the peripheral edge areas 212, 212’ of the first and second half-plates 210, 220 and, thus, completely surrounds the indentation or depression 211 of the first half-plate 210 as well as the indentation or depression 211’ of the second half-plate 220 (see also, e.g., FIG. 5) and the cavity 201 formed between the first and second half-plates 210, 220 as described above. Hence, the cavity 201 forming an interior of the plastic cooling plate 200 is sealed in a fluid-proof manner by the welding line 216 connecting the first and second half-plates 210, 220.

The first half-plate 210 and the second half-plate 220 in a welded state as shown in FIG. 4(B) form a main body of the plastic cooling plate 200. In the y-direction, the main body may have a width large enough to intersect or to be placed before or behind all battery stacks of a battery module according to an embodiment of the present disclosure, for example, the battery cell stacks 10a, 10b, 10c, 10d of the embodiment shown in FIG. 2 or of the embodiment shown in FIG. 3, and to cover, when implemented into a battery module, the main sides of each of the adjacent battery cells. In the z-direction, the main body may have a height corresponding (e.g., exactly or approximately) to or larger than the height of the cases 1’ of the battery cells used in the battery module 10, 10’. Consequently, at least in the usual case that a battery module includes more than one battery cell stack, the main body will have an elongated shape with respect to its extension parallel to the y-z-plane, and its extension along the y-direction is larger than its extension along the z-direction as shown in FIG. 5. In various embodiments, the main body as illustrated in FIG. 4(B) may be supplemented by further features as will be described below with reference to FIG. 5.

Depending on the desired (or designed) cooling performance of the plastic cooling plate 200, a member with higher thermal conductivity may be placed as an inlay 240 in the injection molding of the first half-plate 210 and the second half-plate 220. The inlay 240 may be made of a plastic material. The inlay 240 provides surfaces with a relatively high heat conductivity in the primary contact areas, such as in the areas of the indentations or depressions 211, 211’, while at the same time employing low-cost plastics in other areas of the plastic cooling plate 200. For higher temperature stability in case of a thermal runaway of one or more of the adjacent battery cells, when the plastic cooling plate 200 is implemented into a battery module 10, as described above with reference to FIGS. 2 and 3, the inlay 240 may also be configured to remain stable despite the higher temperatures. In addition, materials with higher temperature stability in comparison to the plastic material of the main body, such as MICA or glass fiber mats, may be overmolded in the primary areas, such as in the areas of the indentations or depressions 211, 211’.

As already described with reference to FIGS. 2 and 3, the plastic cooling plates 200 are each configured to be fluidly connected to the inlet channel C₁ and the outlet channel C₂ of the battery module 10, 10’. The inlet channel C₁ and the outlet channel C₂ may each be led through a peripheral area of the interior 201 of the plastic cooling plate 200. Thus, the plastic cooling plate 200 may include suitable openings through which the inlet channel C₁ and the outlet channel C₂ can be inserted into or pushed through the plastic cooling plate 200. Because the plastic cooling plate is configured to guide coolant from the inlet channel C₁ and the outlet channel C₂, the inlet channel C₁ is arranged within the interior 201 of the plastic cooling plate 200 at a peripheral area close to a first end portion 204 of the plastic cooling plate 200 pointing against the y-direction while the outlet channel C₂ is arranged within the interior 201 of the plastic cooling plate 200 at a peripheral area close to an opposite second end portion 206 of the plastic cooling plate 200 pointing into the y-direction (see, e.g., FIG. 5). Of course, the inlet channel C₁ and the outlet channel C₂ each have openings positioned such that, when implemented into the battery module, coolant can stream from the inlet channel C₁ into each of the plastic cooling plates 200 and, vice-versa, coolant can be discharged into the outlet channel C₁ from each of the plastic cooling plates 200. Consequently, when in use during operation of the battery module, the coolant is conducted along the entire length of the interior 201 of each of the plastic cooling plates 200 from their respective first one end portion 204 to their respective opposite second end portion 206.

A method for controlling a battery module according to an embodiment of the present disclosure will be described in below with reference to FIG. 6, which schematically illustrates an embodiment of the battery module. Similar to the embodiment described above with reference to FIG. 2, the embodiment shown in FIG. 6 features each battery cell being cooled at each of its main sides 13, 14. However, for the sake of simplicity, a battery module 100 with only six battery cells is illustrated as an example, and the six battery cells 1a₁, 1a₂, 1a₃, 1b₁, 1b₂, 1b₃ are arranged in two battery cell stacks, viz. a first battery stack including three battery cells 1a₁, 1a₂, 1a₃ and a second stack including the battery cells 1b₁, 1b₂, 1b₃.

Further, the battery module 100 includes a cooling system including a plurality of plastic cooling plates P₁, P₂, P₃, P₄ as well as an inlet channel C₁ and an outlet channel C₂, which are fluidly connected to each other similar to the arrangement of the embodiment described above with reference to FIG. 2, with the difference, however, being that the last plastic cooling plate, when viewing into the x-direction, is formed by the fourth plastic cooling plate P₄, and the inner plastic cooling plates only include the second plastic cooling plate P₂ and the third plastic cooling plate P₃.

As can be seen in FIG. 6, temperature sensors S₁₁, S₁₂, S₁₃, S₂₁, S₂₂, S₂₃ are attached to the battery cells 1a₁, 1a₂, 1a₃, 1b₁, 1b₂, 1b₃ such that one temperature sensor is provided per battery cell. Each of the temperature sensors S₁₁, S₁₂, S₁₃, S₂₁, S₂₂, S₂₃ is configured to measure a temperature of the respective battery cell 1a₁, 1a₂, 1a₃, 1b₁, 1b₂, 1b₃ that it is attached to and to generate a temperature signal corresponding to the measured temperature. Via respective data lines L₁₁, L₁₂, L₁₃, L₂₁, L₂₂, L₂₃, the temperature sensors S₁₁, S₁₂, S₁₃, S₂₁, S₂₂, S₂₃ are each connected to a controller 40. Thus, the temperature signals generated by the temperature sensors can be transmitted, via the data lines L₁₁, L₁₂, L₁₃, L₂₁, L₂₂, L₂₃, to the controller 40, which is configured to receive and evaluate the temperature signals. In the illustrated embodiment, the date lines L₁₁, L₁₂, L₁₃, L₂₁, L₂₂, L₂₃ may be provided by electrical connections (e.g., wires). In other embodiments, the data lines L₁₁, L₁₂, L₁₃, L₂₁, L₂₂, L₂₃ may be realized as wireless data connections. Further, the controller 40 may be realized as an electric circuit including a microprocessor, a CPU, or the like. The controller 40 may be integrated into a battery management system (BMS) 42 of the battery module 100, as described above in the introductory part of the present disclosure.

The controller 40 is configured to evaluate, based on the received temperature signals generated by the temperature sensors S₁₁, S₁₂, S₁₃, S₂₁, S₂₂, S₂₃, whether or not a thermal run-away is occurring in at least one of the battery cells 1a₁, 1a₂, 1a₃, 1b₁, 1b₂,1b₃. To that end, the controller 40 may be configured to evaluate temperature values based on the received temperature signals and to compare each of these temperature values with a respective first threshold. If the first threshold is exceeded by a temperature value, the controller 40 may assume (or may determine) that a thermal run-away occurs in one of the battery cells. Alternatively or additionally, the controller 40 may also calculate, for each of the received temperature signals, a change of a temperature per time unit, and each of the calculated changes of a temperature per time unit may be compared with a respective second threshold. If the second threshold is exceeded by a change of temperature per unit time, the controller 40 may assume (or determine) that a thermal run-away occurs in one of the battery cells. In some embodiments, the controller 40 may assume (or determine) that a thermal run-away occurs in one of the battery cells, if the first threshold is exceeded and at the same time also the second threshold is exceeded based on the temperature signal for at least one of the battery cells.

If the controller 40 evaluates (or determines) that a thermal run-away is occurring in at least one of the battery cells 1a₁, 1a₂, 1a₃, 1b₁, 1b₂, 1b₃, the controller 40 may generate a control signal for controlling a pump 30. The control signal may be transmitted to the pump 30 via a data line L₀, which may be realized as electrical connection (e.g., a wire) or as a wireless data connection. The pump 30 is fluidly connected, via an inlet I, with an inlet channel C₁. The pump 30 is further fluidly connected with a first reservoir R₁ providing “fresh” coolant, that is, coolant having a temperature suitable for cooling the battery cells 1a₁,1a₂, 1a₃, 1b₁, 1b₂, 1b₃. The reservoir first R₁ may not be included in the battery module 100 but may be provided as an external element. In other embodiments, the first reservoir R₁ may be included in the battery module 100. The pump 30 is configured to move, when being operated, coolant from the first reservoir R₁ into the inlet I of the inlet channel C₁. Further, the outlet O of the outlet channel C₂ is connected to a second reservoir R₂ configured to receive used coolant being discharged from the cooling system via the outlet channel C₂.

During normal operation of the battery module 100, that is, when no thermal run-away is detected, the pump 30 may be operated such that coolant is guided at a first flow rate through each of the plastic cooling plates P₁, P₂, P₃, P₄. However, in embodiments of operating the cooling system, the flow of coolant may be interrupted from time to time. In time intervals, in which the flow of coolant is interrupted, the pump 30 may be deactivated by the controller 40.

If the pump 30 is in a deactivated state and the controller 40 evaluates (or determines) that a thermal run-away is occurring in at least one of the battery cells 1a₁, 1a₂, 1a₃, 1b₁, 1b₂, 1b₃, the controller 40 generates a control signal to activate the pump 30 such that coolant is guided through the plastic cooling plates P₁, P₂, P₃, P₄, for example, either at the first flow rate or at a second flow rate greater than the first flow rate.

If the pump 30 is in an activated state such that coolant is pumped at the first flow rate through the plastic cooling plates P₁, P₂, P₃, P₄, and the controller 40 evaluates (or determines) that a thermal run-away is occurring in at least one of the battery cells 1a₁, 1a₂,1a₃, 1b₁, 1b₂, 1b₃, the controller 40 generates a control signal to control the pump 30 such that coolant is guided through the plastic cooling plates P₁, P₂, P₃, P₄ at the second flow rate greater than the first flow rate.

When one or more of the battery cells 1a₁, 1a₂, 1a_{b}, 1b_{b}, 1b₂, 1b₃ are affected by a thermal run-away, an enormous amount of heat is generated, which causes the plastic material of the plastic cooling plates P₁, P₂, P₃, P₄ to melt in regions at where the plastic cooling plates P₁, P₂, P₃, P₄ are in thermal contact with the affected battery cells because, according to embodiments of the present disclosure, the material of the plastic cooling plates P₁, P₂, P₃, P₄ is configured to melt through in such cases. Due to this process, openings are created in the body of the plastic cooling plates P₁, P₂, P₃, P₄, through which coolant escapes to the outside of the plastic cooling plates P₁, P₂, P₃, P₄. Accordingly, the coolant reaches, via these openings, the battery cells affected by a thermal run-away, which provides an optimal cooling effect to the affected battery cells and extinguishes or at least helps to extinguish the thermal run-away occurring in the failed battery cells.

However, the above-described melting process and the process of creating the openings in the plastic cooling plates can be retarded (or slowed) if fresh coolant is replenished via the plastic cooling plates immediately after the thermal run-away is generated or has been detected by the controller 40 as described above. Hence, in embodiments, the controller 40 is configured to deactivate the pump 30 or to reduce the pumping capacity for a time interval (e.g., a predetermined time interval) upon detection of a thermal run-away in at least one of the battery cells 1a₁, 1a₂, 1a₃, 1b₁, 1b₂, 1b₃. Then, the flow of coolant guided through the plastic cooling plates P₁, P₂, P₃, P₄ is stopped for the time interval or a flow rate of the coolant guided through the plastic cooling plate P₁, P₂, P₃, P₄ is decreased for a time interval (e.g., a predetermined time interval). Hence, a delay of the melting process as described above is avoided, the process of creating openings in the plastic cooling plate P₁, P₂, P₃, P₄ is correspondingly accelerated, and the process of the coolant coming in direct contact with the battery cells affected by the thermal run-away is likewise accelerated.

After expiration of the time interval, the controller 40 then controls the pump 30 such that coolant is guided through the plastic cooling plates P₁, P₂, P₃, P₄, either at the first flow rate or at the second flow rate greater than the first flow rate, as described above.

Although the method of operating a battery module has been described in connection with the embodiment shown in FIG. 6, it is understood that the method of operating can be applied in a corresponding manner to any embodiment of the battery module according to the present disclosure.

### DESCRIPTION OF SOME REFERENCE SYMBOLS

1 battery cell

1’ battery cell case

1a₁, …, 1a₈ battery cells

1b₁, …, 1b₈ battery cells

1c₁, …, 1c₈ battery cells

1d₁, …, 1d₈ battery cells

10, 10’ battery module

10a, 10b, 10c, 10d battery cell stacks

11 lateral side of battery cell case

13 main side of battery cell case

14 main side of battery cell case

16 upper side of battery cell case

30 pump

40 controller

42 battery management system (BMS)

100 battery module

200 plastic cooling plate

201 cavity / interior of plastic cooling plate

204 first end portion of plastic cooling plate

206 second end portion of plastic cooling plate

210 first half-plate

220 second half-plate

211, 211’ indentation or depression

212, 212a, 212b peripheral edge area of first half-plate

212’, 212a’, 212b’ peripheral edge area of second half-plate

214, 214’ nose

214a bridge

216 welding line

240 inlay

C₁ inlet channel

C₂ outlet channel

F₁, F₂ arrows indicating a flow direction

I inlet

L₀, L₁₁, L₁₂, L₁₃, L₂₁, L₂₂, L₂₃ data lines

O outlet

P₁, P₂, P₃, P₄, P₅, P₆, P₇, P₈, P₉ plastic cooling plates

R₁, R₂ reservoirs

S₁₁, S₁₂, S₁₃, S₂₁, S₂₂, S₂₃ temperature sensors

T₁, T₂ battery cell terminals

V venting outlet

x, y, z axes of a Cartesian coordinate system

What is claimed is:

1. A battery module comprising:
a battery cell stack comprising a plurality of battery cells stacked along a first direction;
a plastic cooling plate configured to guide a coolant;
a pump; and
a controller,
wherein each of the plurality of battery cells is in thermal contact with the plastic cooling plate,
wherein the plastic cooling plate comprises a plastic material configured to melt when the plastic material comes into thermal contact with a battery cell affected by a thermal run-away, and
wherein the controller is configured to detect a situation when at least one of the plurality of battery cells is affected by a thermal run-away and to control, after detection of a thermal run-away in the at least one of the plurality of battery cells, the pump such that the coolant is guided through the plastic cooling plate in thermal contact with the battery cell at an increased flow rate in comparison to a flow rate before the detection of the thermal run-away.

2. The battery module as claimed in claim 1, wherein the controller is configured to control the pump such that, after detection of a thermal run-away in the at least one of the plurality of battery cells, the flow of coolant guided through the plastic cooling plate is stopped for a time interval or a flow rate of the coolant guided through the plastic cooling plate is decreased for a time interval.

3. The battery module as claimed in claim 1, wherein each of the plurality of battery cells has a prismatic shape,
wherein, when a number of the battery cell stacks is greater than one, the battery cell stacks are arranged in parallel to each other along the first direction,
wherein the plastic cooling plate extends perpendicular to the first direction, and
wherein the plastic cooling plate crosses each of the battery cell stacks.

4. The battery module as claimed in claim 1, wherein each of the battery cells has main sides, and
wherein at least one of the main sides abuts the plastic cooling plate.

5. The battery module as claimed in claim 1, wherein each of the battery cells is sandwiched between two of the plastic cooling plates.

6. The battery module as claimed in claim 1, wherein the battery cells stack comprises an even number of N battery cells grouped into N / 2 pairs of adjacent battery cells, and
wherein each of the N / 2 pairs of adjacent battery cells is sandwiched between two of the plastic cooling plates.

7. The battery module as claimed in claim 1, wherein the plastic cooling plate comprises a hollow main body assembled from two half-plates made of a first material comprising plastic.

8. The battery module as claimed in claim 7, wherein the two half-plates each comprise a peripheral edge area and are sealed together at their peripheral edge areas to form the hollow main body.

9. The battery module as claimed in claim 7, wherein at least one of the two half-plates comprises a structure for guiding the coolant and for transferring compressive forces between the two half-plates.

10. The battery module as claimed in claim 7, wherein the hollow main body comprises an inlay overmolded by the first material of the two half-plates, and
wherein the inlay comprises a second material different from the first material.

11. The battery module as claimed in claim 10, wherein the second material comprises a higher thermal conductivity than the first material.

12. The battery module as claimed in claim 10, wherein the second material has a higher heat resistance than the first material.

13. A battery system comprising the battery module as claimed in claim 1.

14. A vehicle comprising the battery system as claimed in claim 13.

15. A vehicle comprising the battery module as claimed in claim 1.

16. A method for controlling the battery module as claimed in claim 1, the method comprising:
detecting, by the controller, whether or not at least one of the plurality of battery cells is affected by a thermal run-away; and
after detection of a thermal run-away, controlling the pump such that the coolant is guided through the plastic cooling plate in thermal contact with the battery cell affected by a thermal run-away at a flow rate increased in comparison to a flow rate before the detection of the thermal run-away.

17. The method as claimed in claim 16, wherein after the detection of a thermal run-away and before the controlling of the pump, controlling the pump such that the flow of coolant guided through the plastic cooling plate is stopped for a time interval or a flow rate of the coolant guided through the plastic cooling plate is decreased for a time interval.
